(19) United States
(12) Patent Application Publication
(10) Pub. No.: US 2016/0090525 A1
(43) Pub. Date: Mar. 31, 2016

(54) SILICA GEL AS A VISCOSIFIER FOR SUBTERRANEAN FLUID SYSTEM

(71) Applicant: PQ CORPORATION, Malvern, PA (US)

(72) Inventors: Michael James McDonald, Toronto (CA); Neil Thomas Miller, King of Prussia, PA (US); Xianglian Li, Mississauga (CA); Eugene Albert Elphingstone, Morgan's Point Resort, TX (US); William K. Ott, Houston, TX (US)

(21) Appl. No.: 14/892,051

(22) PCT Filed: May 23, 2014
(86) PCT No.: PCT/US2014/039269

§ 371 Date: Nov. 18, 2015

Related U.S. Application Data
(60) Provisional application No. 61/827,211, filed on May 24, 2013.

(51) Int. Cl. C09K 8/66; C09K 8/80

(52) U.S. Cl. CPC C09K 8/665; C09K 8/80

(57) ABSTRACT

This invention relates to a composition and method of fracturing subterranean formations utilizing a polymerized alkali silicate. The fracturing fluid includes an alkali silicate such as sodium silicate and an acid such as hydrochloric acid. The sodium silicate is polymerized to a silica gel using an acid. The resulting silica gel has a pH from about 2 to less than 7.5.

### CROSS-REFERENCE TO RELATED APPLICATIONS

This application claims priority to U.S. Provisional Patent Application No. 61/827,211 filed in the United States Patent and Trademark Office on May 24, 2013, which is incorporated herein by reference.

### BACKGROUND OF THE INVENTION

1. Field of the Invention

This invention is related to the field of hydraulic fracture fluids but also encompasses other subterranean fluid systems such as drilling fluids, completion fluids and workover fluids. More particularly the present invention describes methods and compositions for polymerizing alkali silicates into silica-based gels and preparing viscous fluid systems for subterranean applications.

2. Description of the Related Art

Hydraulic fracturing techniques will greatly enhance the production of oil, gas and geothermal wells. These techniques are known and generally comprise injecting a liquid, gas or two-phase fluid into a wellbore under high pressure causing fractures to open around the wellbore and into the subterranean formation. Usually a proppant, such as sand or sintered bauxite is introduced into the fracturing fluid to keep the fractures open when the treatment is complete. The propped fracture creates a large area with high-conductivity in the subterranean formation allowing for an increased rate of oil or gas production.

A commonly used fracture fluid is based on water that has been viscosified or “gelled” with a water soluble polymer usually, but not limited to, guar gum, guar gum derivatives, or other polysaccharides. The viscosity of these materials can be further increased by crosslinking the polymer with a multivalent metal ion. The viscosity stability of these gels is dependent on a wide range of factors such as temperature, pH, time, shear, presence of biological activity, radiation, and oxidative materials. To prevent loss of viscosity and broaden operating ranges, it is often necessary to add additives to the fracture fluid. In high temperature applications, it is often necessary to switch from biopolymers to synthetic polymers to achieve the required viscosity.

The economic importance of hydraulic fracturing is well documented. Many oil and gas wells have been made more productive due to the procedure. However, hydraulic fracturing is facing increasing public scrutiny and government regulation. This is particularly acute in some of the shale plays in what were traditionally non-oilfield areas. There is an ongoing need to develop more environmentally friendly fracturing fluids that have the necessary viscosity requirements to carry and transport proppant material.

In addition, industry is also looking to further enhance the performance of fracture fluids to allow for greater and increased production. High temperature reservoirs are particularly challenging for maintaining sufficient viscosity to properly carry proppants. Methods for hydraulic fracturing high temperature reservoirs include higher loading of polymers, use of chemical stabilizers to mitigate polymer breakdown, and the use of synthetic polymers. As well as increasing cost, the increased polymer loading increases the amount of damaging residue remaining in the subterranean formation.

To allow the suspension and transportation of proppant material in the fracture fluid, the viscosity of the fluid must be relatively high under low shear conditions. To allow for pumping and placement into the fracture, the viscosity must be low under high shear conditions. A further objective of this invention is to have a rheology that would allow for the carrying of higher density proppants with corresponding higher crush strength. This would allow the use of metal based products to be used as a proppant.

In order for the hydraulic fracture to be effective, the propping agent must have sufficient mechanical strength to withstand the closure stresses after the removal of the fracture fluid. Insufficient strength will lead to the proppant fracturing and subsequent blocking with proppant fines as well as the closure of fracture. As a rule of thumb, proppant strength is related to density. At lower closure stresses, sand is the preferred proppant choice because of relative low cost and abundance. Higher closure stresses require the use of sintered bauxite. The use of higher density proppant requires the fracture fluid be formulated with a lower concentration of proppant and/or higher viscosity fracture fluids. This increases the cost and decreases the effectiveness of the hydraulic fracture.

Fracture fluid additives can be incorporated into the polymerized silica fracture fluid to impart or add properties. For example a polyacrylamide polymer provides additional friction reduction to the fracturing fluid so it can be more efficiently pumped into the subterranean formation. Similarly, other polymers can be added as friction reducers. Other commonly used fluid loss additives that can be added to silica fracture fluid include, but are not limited to, fluid loss additives, surfactants, gel thickeners, non-emulsifiers, biocides, oxidizers, and enzymes.

The silica gel discovered in this invention also has applications in other subterranean fluid applications including but not limited to; drilling fluids, drill-in fluids, completion fluids, workover fluids and packer fluids. Similar to hydraulic fractures these fluids have their own viscosity requirement to carry and suspend material in an aqueous fluid.

Drilling fluids are the fluid systems used to drill a wellbore. A drilling fluid is comprised of a variety of additives that perform a specific function to allow for successful drilling. Viscosifying agents are added to provide the necessary rheology that will allow for the transport of drill cuttings from the drill bit to the surface. Suspension is also needed to carry weighting materials such as barite in the drilling fluid. For water-based systems, viscosifiers include: clays, natural polymers, synthetic polymers, mixed metal hydroxides and viscoelastic surfactants. Selection of viscosifiers is dictated by cost, desired rheology properties, carrying capacity, temperature stability, ease of use, and health, safety and environmental characteristics.

Along with viscosifiers, another key component of a drilling fluid is an additive that will provide shale stabilization. Certain rock formations such as shales will swell and disperse upon exposure to water. This creates issues with wellbore stability. One of the most effective shale stabilizers is sodium and potassium silicate. As described in Society of Petroleum Engineers paper “Silicate-Based Drilling Fluids: Competent, Cost-effective and Benign Solutions to Wellbore Stability Problems”, alkali silicates in solution will polymerize and precipitate within shale pores to seal and block the flow of fluids and pressure. This sealing and blocking mechanism however is not desirable in fluids systems that will be used in the hydrocarbon reservoir or a geothermal well. Therefore it is critical that fluids viscosified with silica gel do not contain residual alkali silicate for reservoir applications.

Drill-in, completion fluids and workover fluids are used in the reservoir. As suggested by their names, drill-in fluids are used to drill the hydrocarbon producing zone. Completion fluids are used to complete the well and include such operations as perforating the casing, setting the tubing and pumps. Workover fluids are used to re-enter an existing well to perform remedial work such as milling operations, cleaning out sand and replacement of equipment. To maintain wellbore stability and prevent the influx of hydrocarbons these fluids are formulated from brines. The use of brines allows for fluid densities to range from 1.05 to 2.2 specific gravity. Examples of brines include but are not limited to; sodium chloride, potassium chloride, calcium chloride, zinc chloride calcium bromide, zinc bromide as well as potassium acetate, potassium formate and cesium formate. The option exists to combine various brine solutions. Brine selection is based on several factors such as density, cost, environmental considerations and temperature. It is often necessary to viscosify these brine solutions. Viscosifiers must therefore be tolerant to high concentrations of monovalent and divalent ions. Further, viscosities should be tolerant to high temperature conditions. Examples of polymers used in these types of fluid systems are natural products such as: carboxymethyl cellulose, hydroxyethyl cellulose, polysaccharides such as xanthan gum, synthetic polymers such as polyacrylamides as well as viscoelastic surfactants. Each of these viscosifiers offer trade-offs in cost, ease of removal, rheology properties, high temperature tolerance, limitations on type of brine and brine concentration.

Viscoelastic surfactants are non-damaging and have excellent suspension characteristics but are expensive and have limitations to temperature as well as brine density, especially divalent brines. Polymers that are easily removed, such as hydroxyethyl cellulose, are not very thermally stable, and current commercially available thermally stable drilling fluids systems are not easily removable by conventional breakers.

Several of the features of this invention described in hydraulic fracture fluid also make the silica gel of this invention well suited for drilling fluids, drill-in fluids, completion fluids, workover fluids and packer fluids. The high level of suspension offered by the silica gel prevent the dropping or sagging of drill cuttings, weighting material, milled material, produced sand and allows for the carrying of bridging material for lost circulation applications. The size of the silica gel prevents physical invasion into the reservoir rock.

In the case of silica gels above pH 7.5, residual levels of alkali silicate exist within the silica gel pores. The presence of alkali silicate creates the risk of the silicate reacting with the reservoir and hindering the flow of hydrocarbons.

Silica gels made in accordance with the present invention do not contain residual silicate in their pore structures. Further the hydroxyl groups (Si—OH) on the silica remain protonated at a pH of 2 to about 7.5. Above pH 7.5 silica gels show increasing numbers of negatively charged hydroxyl groups (Si—O⁻). The protonated silica has less chemical affinity for the rock surface. This lower retention on the rock surface allows for easier lift-off of the silica gel. Silica gels at pH 7.5 or higher will show greater affinity for the rock and are more likely to change the wettability of the reservoir surface. With the exception of hydrofluoric acid, the silica gel is not acid soluble but the addition of acid or use of delayed acid breakers does result in a loss of viscosity. Fluid loss additives and bridging agents may be added to the silica gel that are acid soluble. Acid requirements would be lower for a silica gel formulated to a pH less than 7.5 vs. a silica gel with a pH greater than 7.5.

### SUMMARY OF THE INVENTION

The present invention is a thixotropic fluid comprising silica gel, said fluid having a suitable rheology for the suspension and transportation of proppant material as well as drill cuttings, weighting material or other material in and/or out of a wellbore. The fluid can be made to a pH in the range from about 2 to about 7. The preferred method of preparation is by alkalization of an acid solution using an alkali silicate. The preparation via alkalization allows for far greater formulation options and covers the pH range of 2 to less than 7.5. In this preparation method a silicate solution is added to an acid solution and the pH is raised to allow for the formation of a silica gel. By adding the alkali silicate to an acid the majority of hydroxyl groups on the silica are left protonated. Other key differences between gels made to pH 2-7.5 vs. 7.5 and higher include the pores space within the silica gel being smaller and having a larger surface area, the absence of unreacted alkali silicate in the fluids within the pores, and the silica gel being in a steady state and less prone to changes in the polymeric structure.

The silica gel has a larger number of bridging links. The increased number of bridges allows for the silica gel to be “milled” to create an increase surface area. The use of very high shear to mill the silica gel enhances rheology, provides greater suspension and allows for silica gels to be made to a lower weight percent of SiO₂. In the case of higher pH silica gels, the lower level of bridge linkages creates a more “mushy” gel that is less responsive to high shear. The type of acid has impact on final rheological properties. Acids evaluated include, but are not limited to: hydrochloric acid, acetic acid, nitric acid, phosphoric acid and sulphuric acid. The silicate solution can be formed using alkali silicates such as, but not limited to, sodium silicate or potassium silicate.

It has been discovered that the application of very high shear levels to the silica gel enhances rheology, provides greater suspension and allows for silica gels to be made to a lower weight percent of SiO₂. The application of very high shear was found to improve silica gels made to a pH range of between pH 2 and 10.5.

In an embodiment of the present invention, the fracturing fluid may contain one or more types of proppant. Suitable proppants include those conventionally known in the art including quartz, sand grains, glass beads, aluminum pellets, ceramics, resin coated ceramics, plastic beads, nylon beads or pellets, and resin coated sands, sintered bauxite and resin-coated sintered bauxite. In one aspect, the fracture fluid may contain a metal based proppant such as steel.

In one aspect of the invention, the amount of proppant in the fracturing fluid may be from about 0.5 to about 25 pounds of proppant per gallon of fracturing fluid.

It has been discovered that aqueous alkali silicates such as, but not limited to, sodium and potassium silicate can be polymerized into a silica gel with novel and useful rheological properties. Further these silica gel fracture fluids offer improved health, safety and environmental characteristics over traditional hydraulic fracture fluids.

In another embodiment of the invention, a silica gel is prepared using a continuous process by the addition of sodium silicate and/or potassium silicate solution to an acid. Under such conditions the sodium silicate reacts with the acid to form a silica gel. Reaction conditions such as pH are selected so that the silica gel is formed over a desired reaction time. The silica gel is shear mixed to a homogeneous mixture. Silica gel properties can be further adjusted with polymers, salts, metals, organic compounds such as alcohol, and hydrophobing agents such as alkoxysilanes.

While the invention describes use in hydraulic fracturing, the invention could also be used in other treatments. Sand control treatments such as gravel packing require a fluid that can suspend particulates and the fluid be removed upon placement of the material in the desired area of the well bore.

The invention has utility in drilling fluids where there is a need for the suspension weighting material such as barite and removal and transportation of drill cuttings. The invention may be used with other commonly used drilling fluid additives such as fluid loss agents, lubricants or shale inhibitors. The invention is well suited for the transportation of lost circulation material such as sized calcium carbonate, fibrous material, walnut hulls etc. The invention has utility in drill-in, completion, workover and packer fluids where brine solutions need to be viscosified to adequately perform their functions.

### BRIEF DESCRIPTION OF THE FIGURES

FIG. 1 is a photograph depicting the settling rate of sand in a polymerized sodium silicate and in guar.

FIG. 2 is a photograph depicting the settling rate of steel shot in a polymerized sodium silicate and in guar.

FIG. 3 is a photograph depicting silica gel subjected to milling under high shear.

FIG. 4 is a photograph depicting effectiveness of a silica gel made to pH of 6 with potassium silica in preventing bitumen accretion.

FIG. 5 is a photograph depicting silica gel made in accordance with the prior art.

### DETAILED DESCRIPTION OF THE PREFERRED EMBODIMENTS

The present invention relates to hydraulic fracture fluids having a pH from about 2 to less than 7.5 comprising a polymerized alkali silicate and methods for use in subterranean formations. The composition of the present invention a low pH highly viscous silica gel. The present invention has numerous advantages that include, but are not limited to;
better proppant carrying capacity;
reduced affinity to rock and metal surfaces;
ability to carry high density proppants including metal-based products;
requires little or no biocide;
can be used in high temperature applications;
can be produced on-site as a batch process or a continuous process;
silica gel can be produced as a concentrate;
can be easily formulated using brackish water, sea water, produced water or flow back water;
can be formulated as a high density brine solutions using salts of acetates, formates, phosphates, chlorides and bromides and used as a drill-in, completion, workover or packer fluid;
water can be easily treated to remove and inactivate metals including heavy metals;
no residual alkali silicate within the silica gel pore structure; and
can be used to viscosify CO₂ and N₂ foam.

It is desirable to have fluids that are thixotropic, having a low viscosity in turbulent flow and a high viscosity at rest. It also desirable to have viscosifier that has little or no affinity to rock or metal surfaces. This allows for easier clean-up, less damage to the hydrocarbon reservoir as well as a lower coefficient of friction.

The use of a highly viscous polymerized sodium silicate was proposed by Elphingstone et al., U.S. Pat. No. 4,215,001 and U.S. Pat. No. 4,231,882. Both patents teach to polymerize the sodium silicate in the pH range from about 7.5 to 8.5. Both these patents describe the method in which an acid is added to a diluted silicate solution to lower the pH of the solution to a range of from about 7.5 to about 8.5. This pH is ideal for rapid gelation but has several disadvantages based on alkali silicates having only moderate tolerance to monovalent salts, no tolerance to divalent metals and forming brittle gels at relatively low SiO₂ by weight concentrations. Further, the desired pH leaves residual negative charge on some of the silanol groups. Further there would be residual amounts of alkali silicate within the silica gel pore structure. Alkali silicates are well known for their shale inhibition structures and thus create potential issues with damage to the hydrocarbon producing reservoir. The very quick reaction time places several restrictions on the method including:
difficulty in control in a continuous process;
greater affinity to rock and metal surfaces;
a fast reaction time that reduces flexibility in production methods;
a pH that has higher friction values;
must be formulated to lower SiO₂ levels;
limited tolerance to monovalent salts being present during gelation; and
not tolerant towards multivalent metal cations being present during gelation.

As noted in U.S. Pat. No. 4,231,882, the polymerized sodium silicate can be produced continuously while pumping or otherwise introduced into the subterranean formation. The rapid gelation would preclude manufacturing the gel in a non-pumping stage such as through a loop. Further the continuous or even semi-continuous manufacturing of the gel would preclude aging of the polymerized silica gel and risk the presence of un-polymerized sodium silicate. The presence of unreacted silicate risks plugging the fracture face of the formation. The presence of negatively charged silanol groups creates greater attraction to the reservoir surface.

In U.S. Pat. No. 4,231,882, the polymerized silicate gel contains an excess acid in the range of 1 to 5% of the mixture. A post addition of hydrochloric acid is used to produce a silica gel with a pH of 1. It is noted the addition of excess acid causes the gel to thin out and to lose thixotropic properties. The loss of viscosity is compensated by the addition of a solution of a water soluble organic solvent and ethoxylated fatty amine.

In U.S. Pat. No. 5,209,297, Ott describes a drilling fluid based on polymerized silicate gel that is a highly viscous thixotropic and suitable for use in high temperature formations. Similar to Elphingstone, the silica gel is made to pH 7.5 and 8.5 by the addition of a diluted acid to a diluted sodium silicate. Continued agitation and shearing is used to avoid mass gelation and improve thixotropic properties. Ott further describes that after gelation, various salts can be added to inhibit swelling and migration of formation clays. Weighting agents, such as barite, hematite, calcium carbonate, or other similar compounds, are added to adjust the fluid density and thereby control formation pressure. Given the addition of acid into sodium silicate and the pH range of 7.5 to 8.5, the silica gel would have the same limitations as Elphingstone. The post addition of salt is indicated for shale stabilization and therefore would be of relatively minimal quantity compared to the salt concentration used in drill-in, completion, work over and packer fluids. Further the salt needs to be added after the formation of the silica gel. Prior to forming the silica gel Ott specifies fresh water. Ott describes mixing or agitation during the polymerization process to break the gel and provide thixotopic properties. The Figure shows a standard prop blade mixer is used to break, disperse and shear the silica gel. These are the same shear conditions that would be applied to drilling fluid polymers such as xanthan gum. This invention proposes non-standard shear conditions to not only break the silica gel but impart sufficient energy to mill the silica gel to increase the surface area of the silica gel.

The present invention proposes making the silica gel having a pH in the range of 2 to less than 7.5. The isoelectric point of polymerized silicate gel is dependent on several factors such as the type of acid. The isoelectric point can be as low as pH 2.0. A small amount of acid can be used to adjust the final pH, but a pH above 2 precludes there being excess acid. Movement towards lower pH does cause loss of rheology but can be compensated by control of solids and reaction times.

While the silica gel can be made by lowering the pH by adding acid to sodium silicate it was discovered that alkalization of an acid with an alkali silicate to acid to raise the pH to the desired range offers several novel and beneficial features. The addition of sodium silicate to acid allows for more controlled gelation times in the pH range of 2 to less than 7.5. Further this method allows for production of the silica gel at a manufacturing site which can then be subsequently diluted at the point of usage.

A silica-based fracture fluid provides benefits over traditional fluids. A silica-based fracture fluid would require minimal biocides. Alkali silicates have minimal bacteria loadings due to the manufacturing process, the inherent high pH and osmotic effects. Further alkali silicates are not a source of nutrition. Likewise, acids such as HCl and acetic acid that are used to polymerize the alkali silicate would also have minimal bacteria load levels. This contrasts with fracture fluids made with carbohydrate based polymers such as guar, carboxymethyl cellulose, hydroxyethyl cellulose, and their various derivatives.

A challenge facing the Hydraulic fracturing industry is the large volume of water that needs to be treated and/or disposed after use. The present invention allows the use of flowback water or produced water with a high salt (NaCl) content as well as other contaminants. Water treatment options for removal/reduction of salt are limited and tend to be expensive. The use of brine water would reduce cost and also reduce the environmental impact of the fracture fluid.

Further, the silica gel fracture fluid could be used to treat certain types of metal contamination that occurs during the pumping and placing of the fracture fluid into a subterranean environment. Along with picking up salt, the fracture fluid also commonly picks up multivalent metals. The post addition of alkali to residual silica gel present in the flowback water would increase negatively charged silanol groups (Si—O⁻) and allow for the absorption of metals onto the silica surface.

Polymerized silicate hydraulic fracture fluids can be made with many standard, commercially available ratio products. Table 1 lists some of the commercially available sodium silicate and potassium silicates. Other forms of alkali silicate also exist, and it is anticipated that these forms of alkali silicate could also be used to produce the invention.

TABLE I

| Alkali | Wt. Ratio | Molar Ratio | SiO₂ | Na₂O | Density | Viscosity |
|---|---|---|---|---|---|---|
| Metal | SiO₂:M₂O | SiO₂:M₂O | (%) | (%) | (lb/gal) | (centipoise) |
| Sodium | 3.75 | 3.87 | 25.3 | 6.75 | 11.0 | 220 |
| | 3.25 | 3.36 | 29.9 | 9.22 | 11.8 | 830 |
| | 3.25 | 3.36 | 28.4 | 8.7 | 11.6 | 160 |
| | 3.22 | 3.33 | 27.7 | 8.6 | 11.5 | 100 |
| | 2.87 | 2.97 | 32.0 | 11.1 | 12.4 | 1,250 |
| | 2.58 | 2.67 | 32.1 | 12.5 | 12.6 | 780 |
| | 2.50 | 2.58 | 26.5 | 10.6 | 11.7 | 60 |
| | 2.40 | 2.48 | 33.2 | 13.85 | 13.0 | 2,100 |
| | 2.20 | 2.27 | 29.2 | 13.3 | 12.5 | — |
| | 2.00 | 2.07 | 29.4 | 14.7 | 12.8 | 400 |
| | 2.00 | 2.07 | 36.0 | 18.0 | 14.1 | 70,000 |
| | 1.90 | 1.96 | 28.5 | 15.0 | 12.7 | — |
| | 1.80 | 1.86 | 24.1 | 13.4 | 12.0 | 60 |
| | 1.60 | 1.65 | 31.5 | 19.7 | 14.0 | 7,000 |
| Potas- | 2.50 | 3.92 | 20.8 | 8.3 | 10.5 | 40 |
| sium | 2.20 | 3.45 | 19.9 | 9.05 | 10.5 | 7 |
| | 2.10 | 3.29 | 26.3 | 12.5 | 11.5 | 1,050 |

In order to further describe the present invention, a series of examples have been prepared and subjected to property and characteristic easements.

Viscosity was measured using a Fann®35 rheometer and American Petroleum Institute test methods. Viscosity readings were taken at 600 rpm, 300 rpm, 200 rpm, 100 rpm, 6 rpm, and 3 rpm. Plastic viscosity (PV)=rheology reading at 600 rpm−rheology reading at 300 rpm, yield point (YP)=rheology reading at 300 rpm−plastic viscosity. Rheology properties of the silica gel were also measured using a Brookfield® RVT rheometer as well as a Brookfield® PVS Rheometer. Rheology modeling using viscosity from the Brookfield® PVS rheometer and the associated software.

Carrying capacity was measured visually by observing the settling rate of 10% sand in a 250 mL graduated cylinder after 1 hour, 2 hours and 24 hours-pictures 1 and 2. Proppant carrying capacity was measured visually by observing the settling rate in a 1 liter cylindrical cone.

Several techniques were used to measure the gelation time of alkali silicate with acid. Rapid gelation can be observed visually while slower gelation times were measured via increases in viscosity using a rheometer. Gelation times were also measure via turbidity readings. As alkali silicate reacts with acid, the silicate molecules increase in size which is reflected in higher turbidity readings. Based on turbidity readings, the properties of the silica gel fracture fluid can be modified by dilution with water, shear, and addition of chemicals among other factors.

Solutions and gels were mixed under “light” shear conditions using a prop blade mixer. Silica gels were also subjected to “high” shear rates using a Ross® LSK mixer at a speed of ˜13,000 rpm.

Coefficient of friction was measured using an OFITE® extreme pressure lubricity tester. This is a common lubricity test that measures the co-efficient of friction between a steel block and a rotating steel ring while immersed in a fluid.

As a starting example for a simple 1 kg sample of silica gel fluid, 23 g of HCl is added to 837 ml of water with constant agitation. 70 g of N® grade sodium silicate is prediluted with 70 g of water. The diluted sodium silicate is added into the diluted acid under constant agitation. A pH meter is used to constantly measure the increase in pH. Upon reaching the desired pH range of 2 to less than 7.5, the addition of sodium silicate is stopped. The option exists to make minor adjustments to pH with the addition of alkali or acid. The above example would produce a silica gel that is 2% SiO₂ by weight.

An example of a variation is to reduce the dilution of acid. 23 g of HCl is added to 418 g water. The diluted 70 g of sodium silicate and 70 g of water is still added in a similar manner as above but upon reaching an initial level of gelation, 418 g of water is added to dilute to 2% SiO₂ by weight.

As will be shown in the subsequent examples, numerous useful variations can be derived that were not possible based on prior art.

### Example 1

Useful silica gels can be made with any acid or acid generating material. As illustration, gels were made with technical grade acids of: hydrochloric acid, sulfuric acid, nitric acid, phosphoric acid and glacial acetic acid. Example 1 illustrates the selection of acid will affect gelation time and rheology properties. Example 1 demonstrates the greater yield point and carrying capacity of silica gels made to a pH range of 2.0 to less than 7.5 compared to silica gels made to a pH of 7.5 or higher. Silica gels were produced to the lower pH range by the alkalization of an acid solution with aqueous alkali silicate.

Tables 2a and 2b illustrate a silica gel produced to pH 4.0 and pH 6.0 from alkalization of diluted acid solutions with diluted sodium silicate. The acid solution was prepared by dilution different types of acids with 3% salt water based on formulated Wt. ratio of acid to N sodium silicate for target gel pH 4.0 and 6.0. A 4.0% SiO₂ concentrate silica gel was produced by quickly metering in N® grade sodium silicate diluted 1 to 1 by weight with water into the different types of diluted acids solution under constant agitation. A pH meter was used to monitor the increase in pH. Upon reaching the desired pH, the addition of diluted sodium silicate was stopped. The SiO₂ concentration in solution was 4.0% by weight of the total weight. The onset of gelation was monitored via turbidity readings. Upon the onset of gelation, the 4% SiO₂ silica gel was then diluted to final 2.5% SiO₂ solution with a 3% solution of salt water. Mixture was milled for 30 seconds to a homogeneous mixture over and above the constant agitation.

Tables 2c and 2d illustrate silica gels produced in a similar manner described in the prior art whereby silica gels were produced by the acidification of sodium silicate with an acid solution. The N® grade sodium silicate solution was prepared by dilution with fresh water or 3% salt water. The different types of acids solution were also diluted with fresh water or 3% salt water. In the case of dilutions made with fresh water, a silica gel could be produced at pH 8.5. In the case of dilutions made with 3% salt water, the silica gelled at pH-10. A 2.5% SiO₂ concentrate silica gel was produced by metering in diluted acid into diluted N® sodium silicate solution under constant agitation. A pH meter was used to monitor the drop in pH. Upon gelation the mixture was shear mixed for 30 s over and above the constant agitation. It should be noted that attempts to make the silica gel via acidification at 4% SiO₂ and then dilute to 2.5% resulted in the silica gel being formed above pH 10, even when dilutions were made with fresh water.

TABLE 2a
2.5 wt % SiO₂, pH 4.0 using 3% salt water as dilution water

| | Gel | Shear | Plastic | Yield | % Sand Suspended | |
|---|---|---|---|---|---|---|
| Acid | Time | Rate | Viscosity | Point | 1 hr | 24 hrs |
| HCl | 165 min. | Light | 23 | 14 | 84% | 79% |
| H₂SO₄ | 190 min. | Light | 22 | 6 | 85% | 72% |
| HNO₃ | 83 min. | Light | 26 | 20 | 90% | 77% |
| H₃PO₄ | 160 min. | Light | 37 | 41 | 100% | 84% |
| CH₃COOH | 120 min. | Light | 22 | 11 | 99% | 74% |

TABLE 2b
Gel at 2.5 wt % SiO₂ and pH 6.0 using
3% salt water as dilution water

| | Gel | Shear | Plastic | Yield | % Sand Suspended | |
|---|---|---|---|---|---|---|
| Acid | Time | Rate | Viscosity | Point | 1 hr | 24 hrs |
| HCl | <1 min | light | 21 | 6 | 77 | 72 |
| H₂SO₄ | <1 min | light | 14 | 6 | 86 | 78 |
| HNO₃ | <1 min | light | 16 | 16 | 92 | 82 |
| H₃PO₄ | 1 min | Light | 13 | 9 | 86 | 76 |
| CH₃COOH | 4 min | Light | 24 | 9 | 84 | 73 |

TABLE 2c
Gel at 2.5% SiO₂ and pH 8.5 using fresh water as dilution water

| | Gel | Shear | Plastic | Yield | % Sand Suspended | |
|---|---|---|---|---|---|---|
| Acid | Time | Rate | Viscosity | Point | 1 hr | 24 hrs |
| HCl | 7 | Light | 35 | 2 | 76 | 66 |
| H₂SO₄ | 8 | Light | 18 | 5 | 80 | 70 |
| HNO₃ | 5 | Light | 51 | 18 | 96 | 80 |
| H₃PO₄ | 5 | Light | 15 | 3 | 84 | 69 |
| CH₃COOH | 5 | Light | 6 | 17 | 76 | 66 |

TABLE 2d
Gel at 2.5% SiO₂ and ~pH 10 using 3% salt water as dilution water

| | Gel | Shear | Plastic | Yield | % Sand Suspended | |
|---|---|---|---|---|---|---|
| Acid | Time | Rate | Viscosity | Point | 1 hr | 24 hrs |
| HCl | 0 | Light | 18 | 7 | 72 | 48 |
| H₂SO₄ | 0 | Light | 16 | 4 | 92 | 62 |
| HNO₃ | 1 | Light | 16 | 7 | 93 | 62 |
| H₃PO₄ | 1 | Light | 20 | 6 | 90 | 66 |
| CH₃COOH | 0 | Light | 26 | 4 | 76 | 54 |

### Example 2

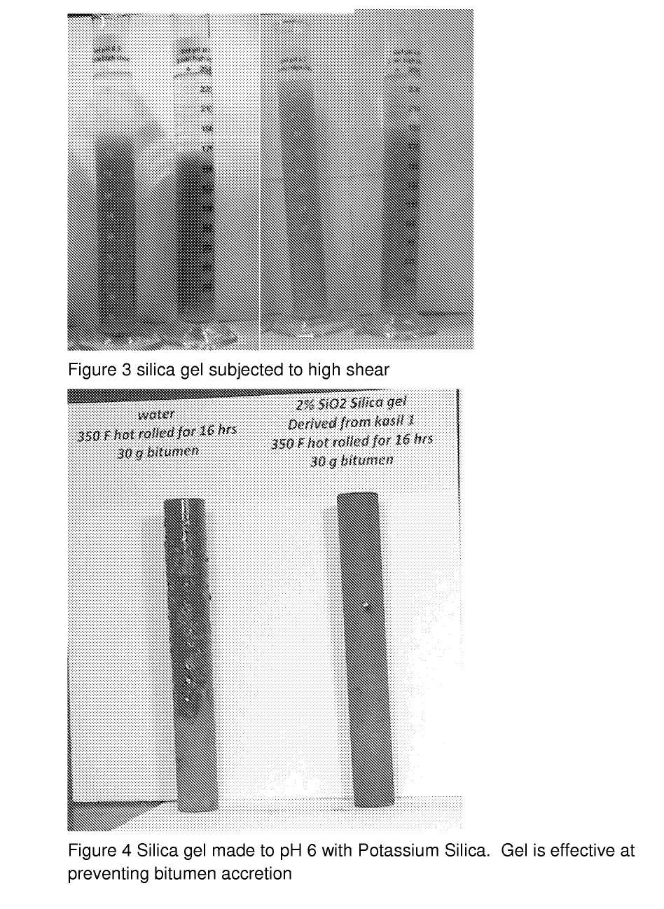

It has been discovered that very high shear conditions improves the carrying capacity and stability of silica gels produced across all pH ranges. A portion of the silica gels produced in Example 1, were subjected to high shear conditions for 3 minutes and tested under the same conditions as Example 1. Tables 3a, 3b, 3c and 3d all show increases in carrying capacity and yield. FIG. 3 shows the sand carrying capacity of the different silica gels after being subjected to high shear.

TABLE 3a
Gel at 2.5% wt SiO₂, pH 4.0 using 3% salt water, high shear

| | Gel | Shear | Plastic | Yield | % Sand Suspended | |
|---|---|---|---|---|---|---|
| Acid | Time | Rate | Viscosity | Point | 1 hr | 24 hrs |
| HCl | 165 min. | High | 18 | 56 | 94 | 82 |
| H₂SO₄ | 190 | High | 17 | 10 | 93 | 79 |
| HNO₃ | 83 | High | 15 | 58 | 98 | 84 |
| H₃PO₄ | 160 | High | 31 | 53 | 100 | 100 |
| CH₃COOH | 120 | High | 12 | 11 | 100 | 100 |

TABLE 3b
Gel at 2.5% wt SiO₂, pH 6.0 using 3% salt water, high shear

| | Gel | Shear | Plastic | Yield | % Sand Suspended | |
|---|---|---|---|---|---|---|
| Acid | Time | Rate | Viscosity | Point | 1 hr | 24 hrs |
| HCl | <1 min | High | 16 | 21 | 93 | 82 |
| H₂SO₄ | <1 min | High | 13 | 10 | 92 | 80 |
| HNO₃ | <1 min | High | 14 | 29 | 98 | 86 |
| H₃PO₄ | 1 min | High | 14 | 16 | 95 | 80 |
| CH₃COOH | 4 min | High | 20 | 25 | 95 | 81 |

TABLE 3c
Gel at 2.5 wt % SiO₂ and pH 8.5 using fresh water, high shear

| | Gel | Shear | Plastic | Yield | % Sand Suspended | |
|---|---|---|---|---|---|---|
| Acid | Time | Rate | Viscosity | Point | 1 hr | 24 hrs |
| HCl | 7 min. | High | 25 | 3 | 88 | 74 |
| H₂SO₄ | 8 | High | 15 | 28 | 94 | 74 |
| HNO₃ | 5 | High | 31 | 43 | 99 | 84 |
| H₃PO₄ | 5 | High | 16 | 21 | 94 | 74 |
| CH₃COOH | 5 | High | 23 | 27 | 92 | 78 |

TABLE 3d
Gel at 2.5 wt % SiO₂ and ~pH 10 using 3% salt water, high shear

| | Gel | Shear | Plastic | Yield | % Sand Suspended | |
|---|---|---|---|---|---|---|
| Acid | Time | Rate | Viscosity | Point | 1 hr | 24 hrs |
| HCl | 0 min. | High | 20 | 13 | 98 | 66 |
| H₂SO₄ | 0 | High | 13 | 15 | 98 | 74 |
| HNO₃ | 1 | High | 15 | 12 | 97 | 65 |
| H₃PO₄ | 1 | High | 13 | 21 | 98 | 74 |
| CH₃COOH | 0 | High | 26 | 14 | 98 | 68 |

### Example 3

Example 3 demonstrates the useful silica gel can be made by diluting a 4.0% SiO₂ concentrate to a final 1.5% SiO₂ solution with a 3% solution of salt water.

Table 4 illustrates the 1.5% SiO₂ silica gels made at pH range of 4.5 to 5.5 show increases in viscosity and carrying capacity by using high shear to mill the silica gel for 5 minutes.

TABLE 4
1.5 wt % SiO₂ and pH 4.5 and 5.5, dilutions made with 3% salt water

| | Gel | Gel | Shear | Viscosity | % Sand Suspended | |
|---|---|---|---|---|---|---|
| Acid | pH | Time | Rate | cP | 1 hr | 24 hrs |
| HCl | 4.5 | 45 min | Light | 120 | 78 | 66 |
| HCl | 5.5 | 3 min | Light | 54 | 74 | 66 |
| HCl | 4.5 | 45 min | High | 376 | 98 | 84 |
| HCl | 5.5 | 3 min | High | 168 | 95 | 74 |

### Example 4

Alkali silicates are used to make precipitated, colloidal and silica gel powder. Example 4 shows that solutions of silica derived from colloidal silica (Nyacol® 1440) and silica gel powder (PQ Britsorb® PM 5108) provide little or no viscosity under similar conditions as the invention.

TABLE 5
Viscosity of a 2.5 wt % SiO₂ produced from colloidal silica and silica gel
powder

| | | | | | % Sand Suspended | |
|---|---|---|---|---|---|---|
| Silica | pH | Shear Rate | PV | YP | 1 hr | 24 hrs |
| Silica | 4 | High | 1 | 2 | 0 | 0 |
| Hydrogel | | | | | | |
| Colloidal | 4 | High | 0 | 0 | 0 | 0 |
| silica | | | | | | |

### Example 5

By keeping the pH of the silica gel less than 7.5 and alkalizing an acid solution with alkali silicate the gelation time can be controlled from seconds to hours. By halting the addition of alkali silicate at a lower pH, gelation times are slowed. Gelation time can be accelerated by raising the level of salt present in the acid as well as the SiO₂ concentration prior to dilution. At the well site a silica gel could be produced in short time allowing for continuous production. Longer gelation time would allow for batch production. Table 6 shows the manipulation of gel times by pH, salt and SiO₂. The silica gels were prepared by dilution of HCl acid with the indicated level of salt water. The SiO₂ concentrate silica gel was produced by quickly metering into the acid the diluted N® grade sodium silicate under agitation. Silica gels produced by the acidification of alkali silicate flash set approaching pH 7.5. Further, alkali silicates have limited tolerance to sodium chloride.

TABLE 6
Gelation times as a function of gelation pH, % NaCl and % SiO₂

| | Weight % SiO₂ | Weight % of NaCl in | Gelation | |
|---|---|---|---|---|
| Gelation pH | Prior to dilution | diluted HCl solution | time | |
| 2.3 | 4.0 | 3 | 120 | hrs |
| 3.0 | 6.0 | 6.0 | 1 | hr |
| 5.0 | 6.0 | 0 | 30 | min |
| 5.0 | 2.0 * | 6.0 | 30 | min |
| 5.7 | 4.0 | 3.0 | <1 | min |

### Example 6

Alkalization also allow for the preparation of a low viscosity, quasi-stable SiO₂ concentrate. A low pH, high SiO₂ by weight solution can be prepared as an initial concentrate. Fresh water or brine is then added to lower the silica concentration. A source of alkali can be used to accelerate the gelation process. A 10% SiO₂ concentrate was prepared by metering in N® grade sodium silicate diluted 2 to 1 by weight with fresh water into an 8% HCl over a 15 minute period under constant agitation. Sodium silicate addition was stopped just prior to the isoelectric point of silica which corresponded to a pH of 1.5. The next day the 10% SiO₂ concentrate was diluted with fresh water to a final SiO₂ content of 2.5% by weight. A small amount of alkali, in this case sodium hydroxide was used to raise the pH to 4.6. Table 7 shows the rheology with and without sand after the 10% silica concentrate was later diluted to 2.5% SiO₂ and the pH adjusted using a small amount of NaOH. Upon gelling, the 2.5% SiO₂ solution was lightly sheared to a homogeneous mixture. Viscosity was measured using a Brookfield PVT rheometer at 50° C.

TABLE 7
Viscosity Comparison (in centipoise)

| Shear rate | pH 4.6 | pH 4.6 + 10% Sand |
|---|---|---|
| 0.34 | 192395 | 206990 |
| 1.36 | 62630 | 89160 |
| 6.81 | 9980 | 13240 |
| 34.1 | 2450 | 2320 |
| 170.3 | 91 | 91 |
| 851.5 | 21 | 28 |

### Example 7

A key performance requirement of a hydraulic fracture fluid as well as drill-in, completion, workover and packer fluids is they are non-damaging to the production zones. The lower pH of the invention shows less affinity to rock and metal. Silica gel adhesion was measured using a glass beaker and a Fann® 35 rheometer rotating at 100 rpm in the centre of the glass beaker. This mimicked cleaning under low shear conditions. The beaker was weighed after exposure to the silica gel. Fresh water was added to the beaker and the rotor was spun at 100 rpm for a duration of one minute. The beaker was allowed to drip dry and was re-weighed.

TABLE 8
Retention of silica gel on a glass beaker at 2.5% wt/wt SiO₂ gel

| | Weight of Silica gel | Weight of silica gel on |
|---|---|---|
| | retained on beaker | beaker after 1 minute flush |
| pH 8.5 acidification | 28.4 g | 8.5 g |
| pH 6.1 alkalization | 27.4 | 4.0 g |
| pH 3.0 alkalization | 8.0 g | 0.4 g |

### Example 8

The lubricity of a drilling, completion or workover fluid is an important property as it determines the torque (rotary friction) and drag (axial friction) in the wellbore. There are numerous economic and technical reasons for wanting to lower the coefficient of friction of the drilling fluid. Table 9 illustrates that by having the silanol groups protonated i.e. lower the pH, the silica gel has less affinity for metal. Polymerized silica gel was prepared using the method described in Example 1 for making a 2.5% SiO₂ silica gel to pH 6 and pH 4 with the alkalization of hydrochloric acid with diluted sodium silicate. The pH 8.5 silica gel was prepared using acidification of diluted sodium silicate with HCl. Coefficient of friction is shown to be significantly lower at the 10 minute reading for silica gels produced to a lower pH.

It is common practice for hydraulic fracture fluids as well as drilling fluids to add a lubricant/drag reducer. In the case of hydraulic fracture fluids, partially hydrolyzed polyacrylamides (PHPAs) are a common class of drag reducers. In drilling fluids they are also used to lower friction as well as other functions such as shale stabilization and solids removal. A small amount of PHPA was by weight to the total volume of the system. Coefficient of friction was measured using an extreme pressure lubricity tester,

TABLE 9
Coefficient of Friction of Silica Gel,
effect of PHPA on CoF and viscosity

| | Coefficient of | Coefficient of |
|---|---|---|
| | Friction 5 min | Friction 10 min |
| water | .36 | .36 |
| 2.5% silica gel, pH 8.5, high shear | .48 | .49 |
| +0.1% wt/wt PHPA | .34 | .27 |
| 2.5% silica gel, pH 6, high shear | .36 | .36 |
| +0.1% wt/wt PHPA | .25 | .25 |
| 2.5% silica gel, pH 4.0, high shear | 0.33 | 0.17 |
| +0.1% wt/wt PHPA | 0.16 | 0.14 |

### Example 9

The viscosity and lower coefficient of friction of silica gel made to pH 2 and less than 7.5 makes it readily suitable for use in drilling fluids. In the case of a silica gel produced from potassium silicate, the silica would have the further benefit of providing available potassium. Potassium salts such as KCl are among the most common drilling fluid additives used to inhibit the swelling and dispersion of shale. Further, potassium-based drilling waste is easier to dispose via surface methods than sodium-based drill waste.

Table 10 demonstrates a silica gel was produced by metering a solution of Kasil®, a 2.5 weight ratio potassium silicate, that was diluted with fresh water into a diluted hydrochloric acid solution and raising the pH to 6.0. Silica gels were made to a final SiO₂ by weight of 2.0%, 2.5% and 3.0% Silica gels were not subject to high shear conditions for testing as a drilling fluid. Table 10 further illustrates the viscosity stability of lower pH silica gels after exposure to high temperatures.

TABLE 10
Viscosity before and after hot roll aging at 350° F.

| | | | | Viscosity readings taken | | |
|---|---|---|---|---|---|---|
| Fann ® 35 | Viscosity Reading taken | | | after hot rolling at | | |
| rheometer | before hot rolling | | | 350° F. for 16 hrs | | |
| taken at | 2% wt | 2.5% | 3% wt | 2% | 2.5% wt | 3.0 wt % |
| 25° C. | SiO₂ | wt SiO₂ | SiO₂ | wt SiO₂ | SiO₂ | SiO₂ |
| 600 rpm | 44 | 61 | 65 | 20 | 35 | 44 |
| 300 rpm | 36 | 52 | 54 | 14 | 23 | 32 |
| 200 rpm | 32 | 48 | 50 | 12 | 19 | 26 |
| 100 rpm | 27 | 42 | 46 | 9 | 16 | 18 |
| 6 rpm | 10 | 13 | 13 | 5 | 6 | 8 |
| 3 rpm | 8 | 11 | 11 | 4 | 5 | 6 |

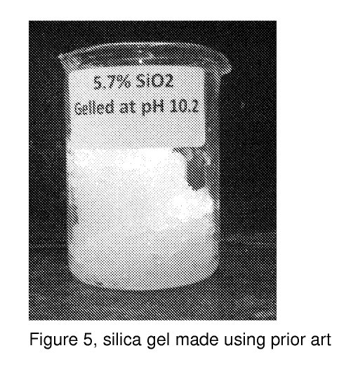

The silica gel was also tested for the performance property of prevention of bitumen accretion. In the case of drilling oil sands, it is desirable to have a polymer that will also prevent the bitumen from sticking to metal surfaces such as the drill pipe. Accretion testing involved placing a metal rod inside an aging cell adding 30 grams bitumen and rolling for 16 hours at 250° F. and 350° F. in a 2% SiO₂ silica gel solution with a pH of 6.0. FIG. 4 shows the results of these tests. As shown in FIG. 4, there was essentially zero bitumen adhesion in the silica gel solution as opposed to the significant bitumen adhesion for the water control.

### Example 10

Completions and workover fluids are formulated using a variety of brine solutions to provide the necessary fluid density in the reservoir. This example illustrates that a cross section of monovalent and divalent brine solutions formulated to different densities using silica gel produced via alkalization to provide the necessary rheology.

As seen in the previous examples, the alkalization process allows for gelation to begin over a wide range of SiO₂ levels in solution after which the SiO₂ concentrate may be diluted to the desired final SiO₂ by weight concentration. In the case of high density brines, the dilution water is substituted for a brine solution. Higher density solutions being achieved by using higher starting levels of SiO₂ therefore requiring greater volumes of brine solution to dilute to a final SiO₂. Depending on the brine solutions, the additional of alkali or acid maybe required to adjust the pH of the brine solution and/or silica gel as the brine is being added.

Table 11a, a silica gel was prepared using the previously described method of a quickly adding diluted sodium silicate into diluted hydrochloric acid so the final SiO₂ concentration was 4% by weight at a pH to 4.0. On the on-set gelation a saturated solution of potassium formate was used to dilute the SiO₂ to 2.5% weight to volume. Mixtures were high sheared mixed for 3 minutes at ˜13,000 rpm. Viscosity was measured at 25° C. and 80° C. using a Fann® 35 rheometer.

Table 11b provides an example of completion/workover fluid made using a saturated solution of sodium chloride. For this example, the SiO₂ concentration was 8% by weight and the pH was 1.5. The NaCl brine solution was metered into SiO₂ solution and the pH controlled to an end point of pH 4.8. Viscosity was measured at 25° C. before hot rolling (BHR) and after hot rolling (AHR) at 90° C. for 16 hours.

Tables 11c and d was made similar to the previous example but this time used a saturated solution of CaCl₂ brine as well as a 50% by weight solution of CaBr₂. In this case viscosity readings were also taken before and after shear.

Table 11e shows a silica concentrate made to pH 1.5 with a 10% by weight SiO₂ concentration. A saturated solution of ZnCl₂ was added to the silica concentrate and the pH was increased to 2.0 using a NaOH to raise the pH.

Table 11f shows a silica concentrate made to 5.7% SiO₂ (the maximum concentration described in the prior art). As shown n FIG. 5, the silica concentrate forms a hard gel at pH 10.2. The agitation and shear described by U.S. Pat. No. 5,209,297 is used to break-up the gel. Saturated solutions of NaCl and CaCl₂ are added to the silica gel under agitation. Viscosity measurements are taken before and after hot rolling. The completions fluids are much more difficult to produce, have reduced viscosity and lower tolerance to heat.

TABLE 11a
4% SiO₂ diluted to 2.5% SiO₂ with a saturated solution of Potassium Formate

| | | | | | | | | 10 s | 10 min |
|---|---|---|---|---|---|---|---|---|---|
| | Density | 600 rpm | 300 rpm | 200 rpm | 100 rpm | 6 rpm | 3 rpm | gel | gel |
| 25° C. | 1.24 | 107 | 83 | 71 | 57 | 29 | 25 | 23 | 25 |
| 80° C. | 1.24 | 58 | 37 | 34 | 27 | 10 | 8 | 9 | 10 |

TABLE 11b
8% SiO₂ solution diluted to 2.5% SiO₂ by volume with a
saturated sodium chloride solution

| | | | | | | | | | 10 s | 10 min |
|---|---|---|---|---|---|---|---|---|---|---|
| | pH | Density | 600 rpm | 300 rpm | 200 rpm | 100 rpm | 6 rpm | 3 rpm | gel | gel |
| 25° C. | 5.1 | 1.15 | 49 | 39 | 34 | 30 | 12 | 10 | 11 | 11 |
| Before hot | | | | | | | | | | |
| rolling | | | | | | | | | | |
| 25° C. After | | 1.15 | 29 | 22 | 17 | 14 | 8 | 6 | 7 | 7 |
| hot rolling | | | | | | | | | | |
| for 16 hrs @ | | | | | | | | | | |
| 90 C. | | | | | | | | | | |

TABLE 11c
8% SiO₂ solution diluted to 2.5% SiO₂ by volume with a
saturated calcium chloride solution

| | | | | | | | | | 10 | 10 |
|---|---|---|---|---|---|---|---|---|---|---|
| | pH | Density | 600 | 300 | 200 | 100 | 6 | 3 | s | min |
| 25° C. - | 4.8 | 1.34 | 63 | 40 | 28 | 19 | 8 | 5 | 7 | 7 |
| no | | | | | | | | | | |
| shear, | | | | | | | | | | |
| Before | | | | | | | | | | |
| hot | | | | | | | | | | |
| rolling | | | | | | | | | | |
| 25° C. - | 4.8 | 1.34 | 103 | 78 | 58 | 53 | 20 | 17 | 17 | 17 |
| high | | | | | | | | | | |
| shear, | | | | | | | | | | |
| Before | | | | | | | | | | |
| hot | | | | | | | | | | |
| rolling | | | | | | | | | | |
| 25° C., | | 1.34 | 82 | 56 | 41 | 31 | 15 | 12 | 12 | 12 |
| After | | | | | | | | | | |
| hot | | | | | | | | | | |
| rolling | | | | | | | | | | |

TABLE 11d
8% SiO₂ solution diluted to 2.5% SiO2 by volume with a saturated calcium
bromide solution

| | | | | | | | | | 10 s | 10 min |
|---|---|---|---|---|---|---|---|---|---|---|
| | pH | Density | 600 rpm | 300 rpm | 200 rpm | 100 rpm | 6 rpm | 3 rpm | gel | gel |
| 25° C. - no | 4.8 | 1.37 | 52 | 26 | 20 | 12 | 5 | 4 | 4 | 4 |
| shear, | | | | | | | | | | |
| BHR | | | | | | | | | | |
| 25° C. - | | 1.37 | 50 | 39 | 28 | 23 | 11 | 8 | 11 | 11 |
| high | | | | | | | | | | |
| shear, BHR | | | | | | | | | | |
| 25° C., AHR | 6.7 | 1.37 | | 31 | 21 | 15 | 12 | 6 | 6 | 7 |

TABLE 11e
10% SiO₂ solution diluted to 2.5% SiO₂ by weight with a saturated
solution of zinc chloride

| | | Initial | 600 | | | | | |
|---|---|---|---|---|---|---|---|---|
| | Density | pH | rpm | 300 rpm | 200 rpm | 100 rpm | 6 rpm | 3 rpm |
| 25 C. | 1.75 | 2.0 | 288 | 210 | 173 | 140 | 91 | 80 |

TABLE 11f
5.7% SiO₂ using prior art. Diluted to 2.5% SiO₂ by weight with saturated
solution of sodium chloride and calcium chloride

| | | | | | | | |
|---|---|---|---|---|---|---|---|
| | Final | 600 | 300 | 200 | | | |
| Density | pH | rpm | rpm | rpm | 100 rpm | 6 rpm | 3 rpm |

25 C. BHR - all samples subjected to high shear before testing
on Fann ® 35 rheometer

| | | | | | | | | |
|---|---|---|---|---|---|---|---|---|
| CaCl₂ | 1.21 | 7.2 | 40 | 22 | 17 | 12 | 6 | 3 |
| NaCl | 1.14 | 9.0 | 36 | 19 | 15 | 11 | 6 | 4 |
| Water | 1.04 | 10.2 | 22 | 14 | 10 | 8 | 4 | 3 |
| (control) | | | | | | | | |

25 C. after hot rolling at 200° F. for 16 hrs

| | | | | | | | |
|---|---|---|---|---|---|---|---|
| CaCl₂ | 7.1 | 32 | 19 | 15 | 11 | 7 | 5 |
| NaCl | 9.7 | 14 | 10 | 8 | 6 | 5 | 3 |
| H₂O | 10.7 | 13 | 9 | 6 | 5 | 4 | 3 |

### Example 11

As demonstrated in Example 10, the protonated silica gel is unreactive towards multivalent metals such as calcium. This also avoids the formation of silicate-metal precipitates in solution. After hydraulic fracturing it is common for the fracture fluid to pick-up metals. In the reservoir a silica gel with reactive hydroxyl group would have a tendency to form metal silicate precipitates which could hinder the flow of hydrocarbons. Once produced and flow back there would be merit in increasing the pH of the silica gel such as through the addition of alkali to increase the pH to 9 or higher. The addition of alkali would result in the formation of alkali silicate as well as negatively charged OH⁻ groups. These active groups could be used to treat out metal contamination. In Example 11, sodium hydroxide was added to simulated flowback water containing a small percentage of residual silica gel at pH less than 7.5 and mixed. A simulated flowback water was produced with common metal contaminations from shale gas fracturing.

TABLE 12
Silica gel frac fluid (SGFF) addition and pH adjustment on metals removal
in self flow back water (SFBW)

| | Adjust pH to 10.3 | | | | | |
|---|---|---|---|---|---|---|
| | Ca | Mg | Sr | Ba | Zn | Fe |
| Flowback water no pH adjust | 14000 mg/l | 1500 mg/l | 1500 mg/l | 860 mg/l | 34 mg/l | 1 mg/l |
| Flow back water + NaOH, pH | 13000 | 140 | 1500 | 810 | 1 | 1 |
| 10.3 | | | | | | |
| Flowback water with 0.38% | 10000 | 53 | 1200 | 620 | 1 | 1 |
| residual SiO₂ by weight, pH | | | | | | |
| raised to 10.3 with NaOH | | | | | | |

### Example 12

A polymerized sodium silicate fracture fluid was formulated using 2.5% SiO₂ fracture fluid at pH 5 wherein diluted sodium silicate was metered into hydrochloric acid. Fracture fluids were also prepared based on 40 pounds guar and 80 pounds guar and 18% by weight of steel shot (0.017″ diameter) was added to both the polymerized sodium silicate fluid and the guar fluids. The polymerized sodium silicate solution was much more effective in maintaining the steel shot in suspension than the guar solution.

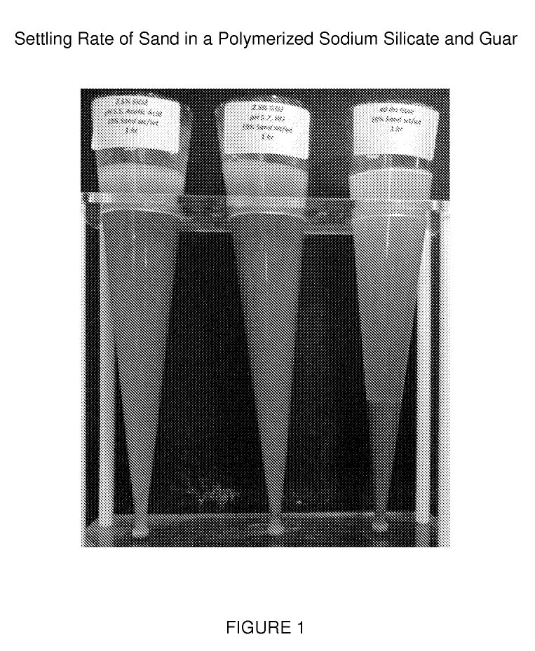

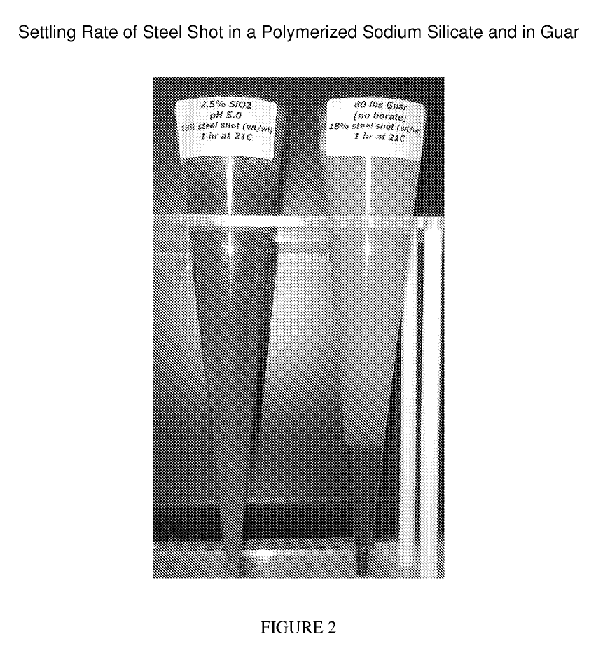

FIG. 1 illustrates a comparison between the high carrying capacity of silica gel an 40 pound guar fracture fluid. FIG. 2 compares the settling rate of 18% weight to weight of steel shot in a 2.5% SiO₂ polymerized hydraulic fracture fluid vs. 80 pound guar fracture fluid. A polymerized sodium silicate gel can be formulated to have a rheology with a very high yield point. The rheology of the silica gel allows for the use of higher levels of proppants as well as denser proppants. The ability to carry high density, high strength proppant would allow the use of the fracture fluid in high closure pressure. A further benefit to carrying metal based proppants is that the proppant can be made to a uniform size which would allow for better conductivity.

Any documents referenced above are incorporated by reference herein. Their inclusion is not an admission that they are material or that they are otherwise prior art for any purpose.

Although the invention is illustrated and described herein with reference to specific embodiments, the invention is not intended to be limited to the details shown. Rather, various modifications may be made in the details within the scope and range of equivalents of the claims and without departing from the invention.

The use of the terms “a” and “an” and “the” and similar referents in the context of describing the vention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Use of the term “about” should be construed as providing support for embodiments directed to the exact listed amount. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A thixotropic fluid comprising silica hydrogel having a pH in the range from about 2 to about 7.5.

2. The fluid of claim 1 wherein the fluid is used for at least one of a viscosifier for aqueous based hydraulic fracturing fluids, drilling fluids, a drill-in fluid, a completion fluid, a workover fluid, and a packer fluid.

3. A thixotropic fluid for the transportation of proppant material comprising silica hydrogel having a pH in the range from about 2 to about 7.5.

4. The fluid of claim 3 wherein said proppant is selected from the group consisting of quartz, sand grains, glass beads, aluminum pellets, ceramics, resin coated ceramics, plastic beads, nylon beads or pellets, resin coated sands, sintered bauxite, resin-coated sintered bauxite, and metal.

5. A thixotropic fracture fluid prepared by sequentially adding an alkali silicate solution to an acid solution to form a silica hydrogel, said fluid having a pH in the range from about 2 to about 7.5.

6. The fluid of claim 5 wherein the silica concentration in the fluid is adjusted by shearing water into the fluid.

7. The fluid of claim 5 wherein the acid solution is formed from one of hydrochloric acid, acetic acid, nitric acid, phosphoric acid, and sulfuric acid.

8. The fluid of claim 5 wherein the alkali silicate solution is formed from at least one of a sodium silicate and a potassium silicate.

9. The fluid of claim 5 further comprising a proppant selected from the group consisting of quartz, sand grains, glass beads, aluminum pellets, ceramics, resin coated ceramics, plastic beads, nylon beads or pellets, resin coated sands, sintered bauxite, resin-coated sintered bauxite, and metal.

10. The fluid of claim 9 wherein said metal is steel.

11. The fluid of claim 5 wherein at least one of polymers, salts, metals, organic compounds, and hydrophobing agents are added to the fluid.

12. A method for making a thixotropic fracture fluid having a pH in the range from about 2 to about 7.5 comprising the steps of
a. preparing an alkali silicate solution
b. preparing an acid solution
c. sequentially adding the silicate solution to the acid solution to form a silica hydrogel; and
d. shearing water into the silica hydrogel to produce a fluid having a desired silica concentration.

13. The method of claim 12 wherein the silicate solution is prepared by diluting a silica concentrate with one of water and brine.

14. The method of claim 12 wherein the acid solution is formed from one of hydrochloric acid and acetic acid.

15. The method of claim 12 wherein the alkali silicate solution is formed from at least one of a sodium silicate and a potassium silicate.

16. The method of claim 12 further comprising the step of adding a proppant to the fluid, said proppant selected from the group consisting of quartz, sand grains, glass beads, aluminum pellets, ceramics, resin coated ceramics, plastic beads, nylon beads or pellets, resin coated sands, sintered bauxite, resin-coated sintered bauxite, and metal.

17. The method of claim 16 wherein said metal is steel.

18. The method of claim 12 further comprising the step of adjusting the properties of the fluid by adding to the fluid at least one of polymers, salts, metals, organic compounds, and hydrophobing agents.

19. The method of claim 12 wherein the post addition water includes at least one of salt and metal contaminants

20. The method of claim 19 wherein the salt is at least one of potassium halides, sodium halides, calcium halides zinc halides, alkali formates, alkali acetates and alkali phosphates.

21. The method of claim 12 comprising the additional step of activating the silica hydrogel with at least one of sodium and potassium hydroxide to form a reactive surface to remove metal and other contaminations.

22. The fluid of claim 6 wherein the hydrogel is prepared at a temperature below 50° C.
